(19) United States
(12) Patent Application Publication
(10) Pub. No.: US 2023/0315612 A1
(43) Pub. Date: Oct. 5, 2023

(54) IN-CIRCUIT EMULATOR DEVICE

(71) Applicant: LAPIS Technology Co., Ltd., Yokohama (JP)

(72) Inventor: Hiroshi YAMASAKI, Yokohama (JP)

(73) Assignee: LAPIS Technology Co., Ltd., Yokohama (JP)

(21) Appl. No.: 18/192,530

(22) Filed: Mar. 29, 2023

(30) Foreign Application Priority Data
Mar. 31, 2022 (JP) 2022-059027

(51) Int. Cl. G06F 11/36

(52) U.S. Cl. CPC G06F 11/3652; G06F 11/364

(57) ABSTRACT

An in-circuit emulator device includes a CPU that executes a program, and outputs or inputs/outputs parameter values that change due to a program being executed, a plurality of trace memories that sequentially store the parameter values outputted by or inputted/outputted to/by the CPU to form a change history of the parameter values, an event detection circuit that detects a specific event that occurs as the CPU executes the program, and an event trace control circuit that stops a storage operation of any one of the plurality of trace memories in response to detection of the specific event by the event detection circuit, and reads and outputs the change history of the parameter value from the one trace memory.

### CROSS REFERENCE TO RELATED APPLICATION

This application is based upon and claims the benefit of priority of the prior Japanese Patent Application No. 2022-059027, filed on Mar. 31, 2022, the entire contents of which are incorporated herein by reference.

### TECHNICAL FIELD

The present invention relates to an in-circuit emulator device that test-executes programs.

### BACKGROUND ART

An in-circuit emulator device is a test device used in developing a microcomputer system, and confirms whether the CPU of the microcomputer system correctly executes programs in place of the CPU itself.

Japanese Patent Application Laid-Open Publication No. 2005-182573 discloses an in-circuit emulator device including: a debugging CPU, a main memory that stores programs and data; a control circuit that controls the debugging CPU during debugging; and a trace memory device that records an execution history of instructions during execution of programs by the debugging CPU, and a history of data accesses to the main memory. In this conventional in-circuit emulator device, data newly written to the main memory through the execution of instructions by the debugging CPU is acquired from information on the data access history recorded in the trace memory device on the basis of information of the instruction execution history recorded in the trace memory device, and then outputted.

### SUMMARY OF THE INVENTION

In such conventional in-circuit emulator devices, it has been typical to perform referencing of an instruction execution history during execution of the program by the debugging CPU and history of data access to the main memory, which are recorded in the trace memory device, after the debugging CPU has completed execution of the program.

However, some users of the in-circuit emulator device wish to immediately test the operation at the occurrence time of an event such as an interruption during execution of the program on the basis of the history of such events, and conventional in-circuit emulator devices presented the problem of not allowing for immediate testing, after the occurrence of the event, of operations that take place at the occurrence time of the event on the basis of the history recorded in the trace memory device.

An object of the present invention is to provide an in-circuit emulator device by which it is possible to immediately reference the operation history of the CPU if a specific event occurs during execution of the program by the CPU.

An in-circuit emulator device according to the present invention includes: a CPU that executes a program and outputs, or inputs and outputs, parameter values that change due to the program being executed; a plurality of trace memories that sequentially store the parameter values outputted by, or inputted to and outputted by, the CPU to form a change history of the parameter values; an event detection circuit that detects a specific event that occurs as the CPU executes the program; and an event trace control circuit that stops a storage operation of any one trace memory among the plurality of trace memories in response to detection of the specific event by the event detection circuit, and reads and outputs the change history of the parameter value from the one trace memory.

According to the in-circuit emulator device of the present invention, if a specific event occurs while the CPU executes a program, it is possible to acquire parameter values such as the program execution address during a time period including the time of occurrence of the event without stopping the program execution operation of the CPU, and thus, it is possible to immediately refer to a change history of the parameter value right after the event occurs, thereby enabling real-time debugging of the program.

### BRIEF DESCRIPTION OF THE DRAWINGS

FIG. 1 is a block diagram showing a configuration of an in-circuit emulator device according to Embodiment 1 of the present invention.

FIG. 2 is a block diagram showing a configuration of an in-circuit emulator device according to Embodiment 2 of the present invention.

### DETAILED DESCRIPTION OF EMBODIMENTS

Embodiments of the present invention will be explained in detail below with reference to the drawings.

### Embodiment 1

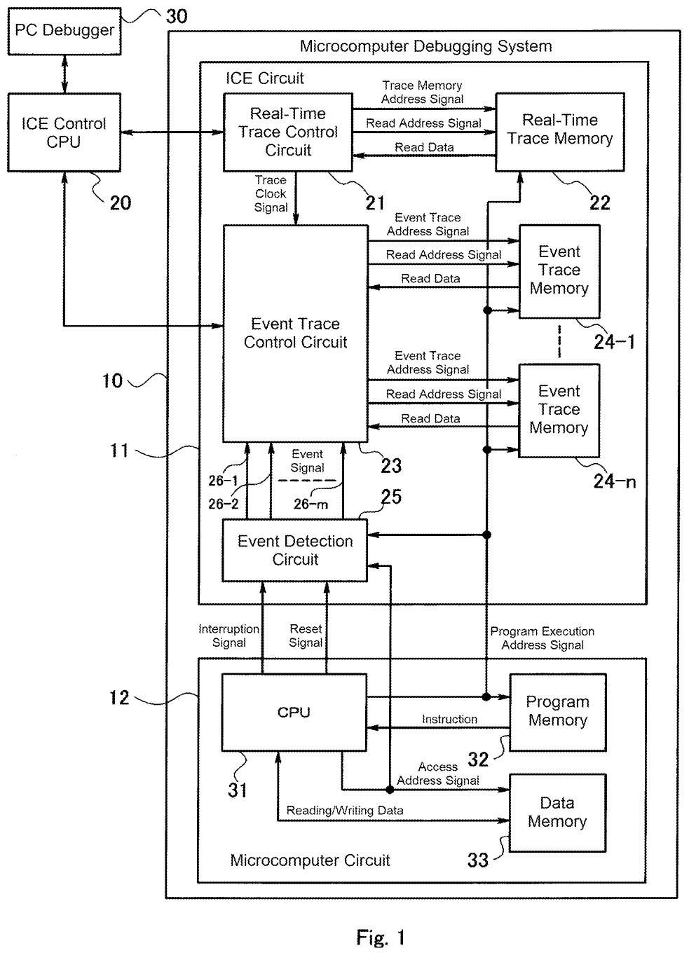

FIG. 1 shows a configuration of an in-circuit emulator device according to Embodiment 1 of the present invention. This in-circuit emulator device includes: a microcomputer debugging system 10 having an in-circuit emulator (ICE) circuit 11 and a microcomputer circuit 12; an ICE control central processing unit (CPU) 20; and a PC debugger 30.

The ICE circuit includes a real-time trace control circuit 21, a real-time trace memory 22, an event trace control circuit 23, event trace memories 24-1 to 24-n (n being an integer of 2 or greater), and an event detection circuit 25. The microcomputer circuit 12 includes a CPU 31, a program memory 32, and a data memory 33.

In the microcomputer circuit 12, the CPU 31 is connected to the program memory 32. The program memory 32 stores programs to be debugged. The CPU 31 executes the programs to be debugged that are stored in the program memory 32. In executing the programs, the CPU 31 generates a program execution address signal, and instructions of the programs to be debugged are read from the storage location thereof in the program memory 32 designated by the address indicated by the program execution address signal. The read instructions are supplied to the CPU 31, and the CPU 31 executes the instructions. The data memory 33 is constituted of a random access memory (RAM), for example. The CPU 31 writes data to the data memory 33 as a result of executing the program to be debugged, and reads the data written to the data memory 33. When the CPU 31 reads or writes data from or to the data memory 33, the CPU 31 supplies, to the data memory 33, an access address signal indicating the address corresponding to the storage location of the data in the data memory 33.

Also, the CPU 31 generates a specific event through execution of the program to be debugged. The specific event indicates a characteristic operational state of the CPU 31. Specific examples of the event include: (1) a program execution address match event in which a program execution address (an address indicated by the program execution address signal) matches a specific address; (2) an interruption event; (3) a reset event; and (4) a data memory address match event in which a writing or reading address (an address indicated by the access address signal) of the data memory 33 matches a specific address.

The microcomputer circuit 12 supplies, to the event detection circuit 25, a reset signal outputted from the CPU 31, an interruption signal, the access address signal indicating the writing or reading address of the data memory 33, and the program execution address signal indicating the execution address in the program memory 32 in order to detect the occurrence of specific events.

The ICE control CPU 20 is connected to the real-time trace control circuit 21 and the event trace control circuit 23 in the ICE circuit 11, transmits instructions to the real-time trace control circuit 21 and the event trace control circuit 23, and receives data outputted from the real-time trace control circuit 21 or the event trace control circuit 23.

The real-time trace control circuit 21 is connected to the real-time trace control circuit 22 having multiple storage locations for storing the program execution addresses. The real-time trace control circuit 21 controls a trace operation including the start and end of a trace of the real-time trace memory 22, and generates a trace memory address signal that sequentially designates storage locations in the real-time trace memory 22 that stores the program execution address.

The program execution address signal outputted by the CPU 31 is supplied to the real-time trace memory 22 and the event trace memories 24-1 to 24-n. The address indicated by the program execution address signal is an output parameter value of the CPU 31 that changes along with execution of the program by the CPU 31. The real-time trace memory 22 stores the address indicated by the program execution address signal in a storage location indicated by the trace memory address signal according to control to start the tracing by the real-time trace control circuit 21. The real-time trace of Embodiment 1 refers to storing addresses indicated by the program execution address signals outputted by the CPU 31 in the output order of the program execution address signals.

The event detection circuit 25 has supplied thereto the above-mentioned reset signal, interruption signal, access address signal, and program execution address signal from the microcomputer circuit 12. The event detection circuit 25 distinguishes between specific events according to the reset signal, interruption signal, access address signal, and program execution address signal, and generates an event signal as a determination result when a specific event occurs. Between the event detection circuit 25 and the event trace control circuit 23 are provided m (m being an integer of 2 or greater) signal lines 26-1 to 26-m. The event signal is supplied to the event trace control circuit 23 by one of the signal lines 26-1 to 26-m.

The event trace control circuit 23 is connected to each of the event trace memories 24-1 to 24-n. The event trace control circuit 23 has supplied thereto a trace clock signal from the real-time trace control circuit 21. The trace clock signal is a timing signal that indicates the respective writing addresses of the event trace memories 24-1 to 24-n, and is synchronized to the timing for designating the addresses of the trace memory address signal described above. The event trace control circuit 23 generates event trace address signals in synchronization with the trace clock signal. The respective event trace address signals are supplied to the event trace memories 24-1 to 24-n, and designate the storage locations of the event trace memories 24-1 to 24-n. The event trace memories 24-1 to 24-n respectively store the addresses indicated by the program execution address signals outputted by the CPU 31 to the storage locations indicated by the event trace address signals.

The event trace memories 24-1 to 24-n are memories with the same number of storage locations, and each of the event trace memories 24-1 to 24-n has a plurality of storage locations for storing the addresses indicated by the program execution address signals, but may have fewer storage locations than the real-time trace memory 22, for example. Here, for ease of explanation, it is assumed that the number of storage locations for storing addresses in each of the event trace memories 24-1 to 24-n is k (an integer of 2 or greater). In the event trace memory 24-1, the event trace address signal designates the order from the first storage location of the event trace memory 24-1, and upon completion of designating the kth storage location, the process of designating the order from the first storage location repeats. In other words, after the address is written in the kth storage location in order, overwriting of data is repeated. This similarly applies to the event trace memories 24-2 to 24-n. However, event trace address signals of the event trace memories 24-1 to 24-n may be independent of each other and designate different storage locations.

Upon receiving an event signal from the event detection circuit 25, the event trace control circuit 23 stops the address storage operation of any one of the event trace memories 24-1 to 24-n undergoing the address storage operation, or in other words, sequentially storing addresses indicated by the program execution address signals. The stoppage of the address storage operation may be performed at a slight delay after receiving the event signal. The delay time is a time corresponding to a few steps of addresses indicated by the program execution address signal, for example. Also, the event trace control circuit 23 controls the ICE control CPU 20 so as to sequentially read the k pieces of data from the respective storage locations of the event trace memories that were caused to stop the address storage operation, starting with older data (address indicated by the program execution address signal). Specifically, when the event trace control circuit 23 supplies a read address signal to the event trace memory 24-1, for example, the data in the storage location designated by the read address signal is read, the data is supplied as read data to the event trace control circuit 23 from the event trace memory 24-1, and the data read operation is performed for the k storage locations.

The PC debugger 30 is connected to the ICE control CPU 20, and is a personal computer (PC) in which a user performs a debugging operation. The PC debugger 30 has a display, and can receive supply of event occurrence notifications and the program execution addresses that are data stored in the event trace memories 24-1 to 24-n and display changes in the program execution addresses when the event occurs.

Next, the operation of the in-circuit emulator device of Embodiment 1 according to this configuration is described.

First, an execution instruction for a program to be debugged is supplied from the PC debugger 30 to the CPU 31 via the ICE control CPU 20 by user operation on the PC debugger 30. The CPU 31 reads instructions from the program stored in the program memory 32 in response to the execution instruction, and starts executing the instructions. That is, the CPU 31 supplies the program execution address signal to the program memory 32 in synchronization with a CPU clock signal, the program memory 32 reads instructions in the storage location of the address indicated by the program execution address signal, and supplies the instructions to the CPU 31. The CPU 31 executes the supplied instructions.

The address indicated by the program execution address signal is a count value of a program counter (not shown) in the CPU 31. The count value of the program counter is updated every time the CPU 31 executes the supplied instructions. The count value of the program counter changes in sequence from an initial value, but depending on the instruction in the program, the count value can jump to a specific value.

The program execution address signal is supplied to the real-time trace memory 22, the event trace memories 24-1 to 24-n, and the event detection circuit 25. Every time the program execution address signal is supplied, the real-time trace memory 22 stores the address indicated by the program execution address signal in the storage location indicated by the trace memory address signal. The trace memory address signal is, as described above, supplied from the real-time trace control circuit 21.

The event trace memories 24-1 to 24-n each store the address indicated by the program execution address signal in the storage location indicated by the event trace address signal every time the program execution address signal is supplied. The event trace address signals are, as described above, each supplied from the real-time trace control circuit 23. Thus, the items being traced by the real-time trace memory 22 and the event trace memories 24-1 to 24-n are addresses indicated by the program execution address signals, and the addresses indicate storage locations of the program memory 32. Also, the event trace memories 24-1 to 24-n can store the latest k addresses, which are fewer in number compared to the real-time trace memory 22, for example.

The event detection circuit 25 has supplied thereto the above-mentioned reset signal, interruption signal, and access address signal from the microcomputer circuit 12, in addition to the program execution address signal. As described above, the event detection circuit 25 distinguishes between specific events according to the reset signal, interruption signal, access address signal, and program execution address signal, and generates an event signal when a specific event occurs.

Here, a configuration is described in which a signal line that transmits an event signal for each event and event trace memories that use stored data are set in advance as described below. For a first event in which the program execution address matches a specific address, a first event signal is supplied to the event trace control circuit 23 via the signal line 26-1, and data stored in the event trace memory 24-1 is used. For a second event that is an interruption, a second event signal is supplied to the event trace control circuit 23 via the signal line 26-2, and data stored in the event trace memory 24-2 is used. For a third event that is a reset, a third event signal is supplied to the event trace control circuit 23 via the signal line 26-3, and data stored in the event trace memory 24-3 is used. For a fourth event in which the reading or writing address of the data memory 33 matches a specific address, a fourth event signal is supplied to the event trace control circuit 23 via the signal line 26-4, and data stored in the event trace memory 24-4 is used.

In the event detection circuit 25, if a first event is detected, or in other words, it is detected that the program execution address according to the program execution address signal matches a specific address, then the first event signal is supplied to the event trace control circuit 23 via the signal line 26-1. The event trace control circuit 23 notifies the ICE control CPU 20 of the occurrence of the first event and stops the supply of the event trace address signal to the event trace memory 24-1. As a result, a notification of the occurrence of the first event is supplied to the PC debugger 30 via the ICE control CPU 20, and the occurrence of a program execution address match that is the first event is displayed in the display. As a result of supply of the event trace address signal to the event trace memory 24-1 being stopped, the event trace memory 24-1 stops the event trace operation, which is the storing of the address indicated by the program execution address signal supplied from the CPU 31. Also, the event trace control circuit 23 sets a stop flag for the event trace memory 24-1 in order to indicate the stoppage of the event trace operation by the event trace memory 24-1.

The event trace control circuit 23 supplies the read address signal to the event trace memory 24-1, reads the k pieces of address data stored in the event trace memory 24-1 starting with the oldest data, and supplies the read address data sequentially as signals to the ICE control CPU 20. As a result, the PC debugger 30 supplies, via the ICE control CPU 20, the reading address data signal, or in other words, the program execution address signal in the time period including the time of occurrence of the program execution address match, and thus, the display of the PC debugger 30 displays the change in address indicated by the program execution address signal.

Upon completing reading of the address data from the event trace memory 24-1, the event trace control circuit 23 resumes the supply of the event trace address signal to the event trace memory 24-1. As a result, the event trace memory 24-1 resumes storing the address, indicated by the program execution address signal supplied from the CPU 31 according to the event trace address signal, in the storage location indicated by the event trace address signal. Also, the event trace control circuit 23 resets the stop flag for the event trace memory 24-1.

In the event detection circuit 25, if a second event is detected, or in other words, the occurrence of an interruption is detected, then the second event signal is supplied to the event trace control circuit 23 via the signal line 26-2. The event trace control circuit 23 notifies the ICE control CPU 20 of the occurrence of the second event and stops the supply of the event trace address signal to the event trace memory 24-2. As a result, a notification of the occurrence of the second event is supplied to the PC debugger 30 via the ICE control CPU 20, and the occurrence of an interruption event that is the second event is displayed in the display. As a result of supply of the event trace address signal to the event trace memory 24-2 being stopped, the event trace memory 24-2 stops the event trace operation, which is the storing of the address indicated by the program execution address signal supplied from the CPU 31. Also, the event trace control circuit 23 sets a stop flag for the event trace memory 24-2 in order to indicate the stoppage of the event trace operation by the event trace memory 24-2.

The event trace control circuit 23 supplies the read address signal to the event trace memory 24-2, reads the k pieces of address data stored in the event trace memory 24-2 starting with the oldest data, and supplies the read address data sequentially as signals to the ICE control CPU 20. As a result, the PC debugger 30 supplies, via the ICE control CPU 20, the reading address data signal, or in other words, the program execution address signal in the time period including the time of occurrence of the interruption event, and thus, the display of the PC debugger 30 displays the change in address indicated by the program execution address signal.

Upon completing reading of the address data from the event trace memory 24-2, the event trace control circuit 23 resumes the supply of the event trace address signal to the event trace memory 24-2. As a result, the event trace memory 24-2 resumes storing the address, indicated by the program execution address signal supplied from the CPU 31 according to the event trace address signal, in the storage location indicated by the event trace address signal. Also, the event trace control circuit 23 resets the stop flag for the event trace memory 24-2.

In the event detection circuit 25, if a third event is detected, or in other words, the occurrence of a reset is detected, then the third event signal is supplied to the event trace control circuit 23 via the signal line 26-3. The event trace control circuit 23 notifies the ICE control CPU 20 of the occurrence of the third event and stops the supply of the event trace address signal to the event trace memory 24-3. As a result, a notification of the occurrence of the third event is supplied to the PC debugger 30 via the ICE control CPU 20, and the occurrence of a reset event that is the third event is displayed in the display. As a result of supply of the event trace address signal to the event trace memory 24-3 being stopped, the event trace memory 24-3 stops the event trace operation, which is the storing of the address indicated by the program execution address signal supplied from the CPU 31. Also, the event trace control circuit 23 sets a stop flag for the event trace memory 24-3 in order to indicate the stoppage of the event trace operation by the event trace memory 24-3.

The event trace control circuit 23 supplies the read address signal to the event trace memory 24-3, reads the k pieces of address data stored in the event trace memory 24-3 starting with the oldest data, and supplies the read address data sequentially as signals to the ICE control CPU 20. As a result, the PC debugger 30 supplies, via the ICE control CPU 20, the reading address data signal, or in other words, the program execution address signal in the time period including the time of occurrence of the reset event, and thus, the display of the PC debugger 30 displays the change in address indicated by the program execution address signal.

Upon completing reading of the address data from the event trace memory 24-3, the event trace control circuit 23 resumes the supply of the event trace address signal to the event trace memory 24-3. As a result, the event trace memory 24-3 resumes storing the address, indicated by the program execution address signal supplied from the CPU 31 according to the event trace address signal, in the storage location indicated by the event trace address signal. Also, the event trace control circuit 23 resets the stop flag for the event trace memory 24-3.

In the event detection circuit 25, if a fourth event is detected, or in other words, it is detected that the reading or writing address of the data memory 33 matches a specific address, then the fourth event signal is supplied to the event trace control circuit 23 via the signal line 26-4. The event trace control circuit 23 notifies the ICE control CPU 20 of the occurrence of the fourth event and stops the supply of the event trace address signal to the event trace memory 24-4. As a result, a notification of the occurrence of the fourth event is supplied to the PC debugger 30 via the ICE control CPU 20, and the occurrence of a match of the reading or writing address of the data memory that is the fourth event is displayed in the display. As a result of supply of the event trace address signal to the event trace memory 24-4 being stopped, the event trace memory 24-4 stops the event trace operation, which is the storing of the address indicated by the program execution address signal supplied from the CPU 31. Also, the event trace control circuit 23 sets a stop flag for the event trace memory 24-4 in order to indicate the stoppage of the event trace operation by the event trace memory 24-4.

The event trace control circuit 23 supplies the read address signal to the event trace memory 24-4, reads the k pieces of address data stored in the event trace memory 24-4 starting with the oldest data, and supplies the read address data sequentially as signals to the ICE control CPU 20. As a result, the PC debugger 30 supplies, via the ICE control CPU 20, the reading address data signal, or in other words, the program execution address signal in the time period including the time of occurrence of a reading or writing address match event of the data memory, and thus, the display of the PC debugger 30 displays the change in address indicated by the program execution address signal.

Upon completing reading of the address data from the event trace memory 24-4, the event trace control circuit 23 resumes the supply of the event trace address signal to the event trace memory 24-4. As a result, the event trace memory 24-4 resumes storing the address, indicated by the program execution address signal supplied from the CPU 31 according to the event trace address signal, in the storage location indicated by the event trace address signal. Also, the event trace control circuit 23 resets the stop flag for the event trace memory 24-4.

As described above, when stopping the event trace operations of the event trace memories 24-1 to 24-4, a stop flag is set for the event trace memories 24-1 to 24-4. If, after the stop flag is set for the event trace memory 24-1, a first event is detected indicating that a program execution address from the program execution address signal matches a specific address, for example, then as a result of the setting of the stop flag for the event trace memory 24-1, address data is read from an event trace memory other than the event trace memory 24-1 among the event trace memories 24-1 to 24-n. A plurality of event trace memories may be allocated for each event, for example. A configuration may be adopted in which, if the first event is allocated to the event trace memories 24-1 and 24-5, then if another first event occurs while the event trace operation of the event trace memory 24-1 is stopped, then the address data is read from the event trace memory 24-5. This similarly applies to other events.

Thus, in the in-circuit emulator device of Embodiment 1, if an event occurs while the CPU 31 executes a program, it is possible to acquire the program execution address during a time period including the time of occurrence of the event without stopping the program execution operation of the CPU 31, and thus, it is possible to immediately refer to a change history of the program execution address right after the event occurs, thereby enabling real-time debugging of the program.

### Embodiment 2

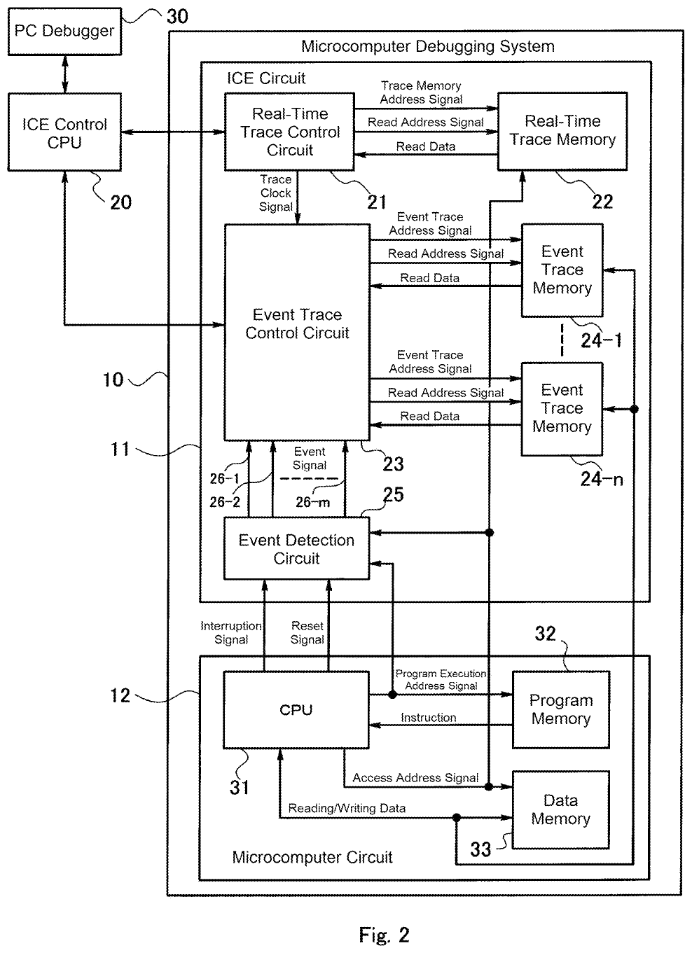

FIG. 2 shows a configuration of an in-circuit emulator device according to Embodiment 2 of the present invention. In the in-circuit emulator device of Embodiment 2, the real-time trace memory 22 is connected to the supply line for the access address signal from the CPU 31 to the data memory 33. The access address signal outputted by the CPU 31 is supplied to the real-time trace event trace memory 22. Also, the event trace memories 24-1 to 24-n are connected to the supply line for the reading or writing, or reading and writing (hereafter, “reading/writing”) data between the CPU 31 and the data memory 33. The reading/writing data that is inputted to and outputted by the CPU 31 is supplied as a signal to the event trace memories 24-1 to 24-n. In other words, the items being traced by the real-time trace memory 22 are addresses indicated by the access address signals, and the addresses indicate storage locations of the data memory 33. The items being traced by the event trace memories 24-1 to 24-n are reading/writing data. In Embodiment 2, the reading/writing data is the input/output parameter value of the CPU 31 that changes as the CPU 31 executes a program.

Every time the access address signal is supplied, the real-time trace memory 22 stores the address indicated by the access address signal in the storage location indicated by the trace memory address signal. The event trace memories 24-1 to 24-n each store the reading/writing data for the storage location, indicated by the access address signal, in the storage location indicated by the event trace address signal. The event trace memories 24-1 to 24-n can store the latest k data, which are fewer in number compared to the real-time trace memory 22. Thus, the event trace operation of each of the event trace memories 24-1 to 24-n is stored as reading/writing data that is inputted to or outputted by, or inputted to and outputted by (hereafter, “inputted/outputted to/by”), the CPU 31, which is a difference from Embodiment 1.

In explaining a case in which, in the event detection circuit 25, a first event is detected, or in other words, it is detected that the program execution address from the program execution address signal matches a specific address, the first event signal is supplied to the event trace control circuit 23 via the signal line 26-1. The event trace control circuit 23 notifies the ICE control CPU 20 of the occurrence of the first event and stops the supply of the event trace address signal to the event trace memory 24-1. As a result, a notification of the occurrence of the first event is supplied to the PC debugger 30 via the ICE control CPU 20, and the occurrence of a program execution address match that is the first event is displayed in the display. As a result of supply of the event trace address signal to the event trace memory 24-1 being stopped, the event trace memory 24-1 stops the event trace operation, which is the storing of the reading/writing data. Also, the event trace control circuit 23 sets a stop flag for the event trace memory 24-1 in order to indicate the stoppage of the event trace operation by the event trace memory 24-1.

The event trace control circuit 23 supplies the read address signal to the event trace memory 24-1, reads the k pieces of the reading/writing data stored in the event trace memory 24-1 starting with the oldest data, and supplies the acquired reading/writing data sequentially as signals to the ICE control CPU 20. As a result, the PC debugger 30 supplies, via the ICE control CPU 20, the acquired reading/writing data, or in other words, the reading/writing data in the time period including the time of occurrence of the program execution address match, and thus, the display of the PC debugger 30 displays the change in the reading/writing data.

Upon completing reading of the reading/writing data from the event trace memory 24-1, the event trace control circuit 23 resumes the supply of the event trace address signal to the event trace memory 24-1. As a result, the event trace memory 24-1 resumes storing the reading/writing data, supplied from the CPU 31 or the data memory 33 according to the event trace address signal, in the storage location indicated by the event trace address signal. Also, the event trace control circuit 23 resets the stop flag for the event trace memory 24-1.

The configuration is similar to Embodiment 1 regarding the occurrence of the second to fourth events aside from the fact that the reading/writing data is traced, and thus, explanation thereof is omitted here.

Thus, in the in-circuit emulator device of Embodiment 2, if an event occurs while the CPU 31 executes a program, it is possible to acquire the writing data to the data memory 33 or the reading data read from the data memory 33 by the CPU 31 during a time period including the time of occurrence of the event without stopping the program execution operation of the CPU 31, and thus, it is possible to immediately refer to a change history of the reading/writing data right after the event occurs, thereby enabling real-time debugging of the program.

In the above embodiments, specific events include a program execution address match event in which a program execution address matches a specific address, an interruption event, a reset event, and a data memory address match event in which a writing or reading address of the data memory 33 matches a specific address, but the present invention is not limited to these events. The change history may be acquired for the program execution address or the reading/writing data during the time period including the occurrence of another event such as a specific calculation result being generated by the CPU 31.

In Embodiment 1, the change history of the program execution address is acquired immediately after an event, and in Embodiment 2, the change history of the reading/writing data is acquired immediately after an event, but a configuration may be adopted in which both the change history of the program execution address and the change history of the reading/writing data are acquired immediately after an event.

Also, parameter values outputted by the CPU 31 during execution of a program may include an address indicated by the program execution address signal outputted from the CPU 31 to the program memory 32 in the case of Embodiment 1, the reading/writing data inputted/outputted to/by the CPU 31 for the data memory 33 in the case of Embodiment 2, or data such as the port number outputted from the CPU 31 for driving various peripheral devices (not shown), for example.

What is claimed is:

1. An in-circuit emulator device, comprising:
a central processing unit (CPU) that executes a program and outputs, or inputs and outputs, parameter values that change due to the program being executed;
a plurality of trace memories that sequentially store the parameter values outputted by, or inputted to and outputted by, the CPU to form a change history of the parameter values;
an event detection circuit that detects a specific event that occurs as the CPU executes the program; and
an event trace control circuit that stops a storage operation of any one trace memory among the plurality of trace memories in response to detection of the specific event by the event detection circuit, and reads and outputs the change history of a parameter value from the one trace memory.

2. The in-circuit emulator device according to claim 1,
wherein the event trace control circuit stops the storage operation of the one trace memory after a predetermined delay from detection of the specific event by the event detection circuit.

3. The in-circuit emulator device according to claim 1,
wherein the event trace control circuit resumes the storage operation of the one trace memory after reading the change history of the parameter value from the one trace memory.

4. The in-circuit emulator device according to claim 1,
wherein the event trace control circuit stops a storage operation of another trace memory excluding the one trace memory among the plurality of trace memories in response to detection of the specific event by the event detection circuit while the storage operation of the one trace memory is stopped, and reads and outputs the change history of the parameter value from said other trace memory.

5. The in-circuit emulator device according to claim 1, further comprising:
a program memory that stores the program,
wherein the parameter value is an address of a storage location of the program memory indicating a program execution address signal outputted by the CPU.

6. The in-circuit emulator device according to claim 1, further comprising:
a data memory that stores data,
wherein the parameter value is reading or writing data, or reading and writing data, that is inputted to or outputted by, or inputted to and outputted by, the CPU for the data memory.

7. The in-circuit emulator device according to claim 1,
wherein the specific event is at least one of:
an address indicated by a program execution address signal outputted by the CPU matching a first specific address,
an interruption of execution of the program,
a reset performed during execution of the program, or
an address indicated by an access address signal outputted by the CPU matching a second specific address.
